(19) United States
(12) Patent Application Publication
(10) Pub. No.: US 2021/0312469 A1
(43) Pub. Date: Oct. 7, 2021

(54) System and Method For Satisfying Suitability Regulatory Requirements

(71) Applicant: Troutwood, LLC, Pittsburgh, PA (US)

(72) Inventors: Eugene M. Natali, JR., Pittsburgh, PA (US); Jeffrey Richard Davidek, Pittsburgh, PA (US); Dorian Brown, Pittsburgh, PA (US)

(73) Assignee: Troutwood, LLC, Pittsburgh, PA (US)

(21) Appl. No.: 17/223,576

(22) Filed: Apr. 6, 2021

Related U.S. Application Data
(60) Provisional application No. 63/005,868, filed on Apr. 6, 2020.

(51) Int. Cl. G06Q 30/00; G06Q 40/06; G06F 21/31

(52) U.S. Cl. CPC G06Q 30/018; G06F 21/31; G06Q 40/06

(57) ABSTRACT

A regulatory compliance system is provided and generally includes an investment module and a suitability module means. The investment module is provided for user input of user authentication and an investment request related to year of retirement, the investment module includes a means for submitting a user questionnaire form required for regulatory compliance of the investment request. The suitability module means provides verification of the questionnaire form data of the user and authorizes completion of the investment request in view of the year of retirement.

### CROSS-REFERENCE TO RELATED APPLICATION

This application claims the benefit of U.S. Provisional Patent Application No. 63/005,868, filed on Apr. 6, 2020.

### FIELD OF INVENTION

The present invention relates to a regulatory compliance system to verify suitability rule requirements established under federal regulations or rules from a self-regulatory organization. More particularly, the regulatory compliance system includes a suitability module that addresses suitability questions to satisfy FINRA requirements.

### BACKGROUND

Approximately 115 million Americans do not invest. Only 3% of children born in 2019 are likely to have a pension fund. Financial challenges to the general population are numerous, including a student loan crisis, which continues to grow. Corporations and even municipal and state governments are freezing or eliminating their pension plans. The minimum age for Social Security eligibility has risen and may continue to rise as its Trust Fund deficit grows. This cumulative reduction of the United States retirement safety net is an issue of national importance. The demand and need to help Americans, particularly young Americans, develop viable plans to achieve financial stability is very high. Investments in the stock market is one suitable route to ensure a user's financial stability in the future, as with proper selection, care, and management, the investment value has historically appreciated over an extended period of time.

Changing retirement demographics and investment vehicles have necessitated a change in the manner by which users tend save for retirement, as employers shy away from offering employer managed plans. As a result of this change, the ability for users to retire, save, and invest ought to supersede all other financial and savings goals except for true necessities and emergencies (health, food, shelter, etc.)

It is estimated that 48% of Americans don't invest, representing more than 115 million potential investors; and among the 52% of the US population that do invest, many have vastly lower savings than will be needed in retirement. Reasons for the savings shortfall include investor intimidation, and the changing retirement dynamic. The current investor approval verification process is invasive and burdensome, and as a result intimidates and tends to deter potential investors from investing. This has become more of an issue in response to the trend of users being more responsible for their retirement savings, rather than employer controlled plans, such as traditional pension funds. This changing retirement dynamic necessitates additional changes in the ability and ways that people replace traditional pension funds in their personal saving/investing mediums.

It has been observed that many users attempt to open accounts with the traditional means and processes, with a high rate of failure. From personal observation, it appears that among potential investors ranging from college students to pension trustees, roughly 50% do not complete the approval process for a variety of reasons, such as the approval process takes too long, is too cumbersome, intimidating or confusing. A difficult approval process before investing runs the risk of turning off young people from investing, and such a risk to their respective retirement savings is greater than the risk of those users investing their retirement savings into a well-diversified index fund, such as the S&P 500.

The approval process is a rule requirement that is applied to the Broker-dealers that serve to facilitate investors' entry into the stock market. The Financial Industry Regulatory Authority (FINRA) is authorized by Congress to protect America's investors by making sure the broker-dealer industry operates fairly and honestly. FINRA oversees more than 634,000 brokers across the country—and analyzes billions of daily market events. The website FINRA.ORG explains that FINRA is a government-authorized not-for-profit organization that oversees U.S. broker-dealers, provides guidance regarding suitability obligations, indicating that they are critical to ensuring investor protection and promoting fair dealings with customers and ethical sales practices. FINRA Rule 2111 governs general suitability obligations, while certain securities are covered under other rules that may contain additional requirements.

FINRA Rule 2111 requires that a firm or associated person have a reasonable basis to believe a recommended transaction or investment strategy involving a security or securities is suitable for the customer. This is based on the information obtained through reasonable diligence of the firm or associated person to ascertain the customer's investment profile.

The rule states that the customer's investment profile “includes, but is not limited to, the customer's age, other investments, financial situation and needs, tax status, investment objectives, investment experience, investment time horizon, liquidity needs [and] risk tolerance,” among other information. A broker's “recommendation,” which is based on the facts and circumstances of a particular case, is the triggering event for application of the rule.

Brokers must have a firm understanding of both the product and the customer, according to Rule 2111. The lack of such an understanding itself violates the suitability rule.

What is needed is a change to the process for determining suitability as an investor, with the aim of reducing the potential of investor intimidation attributable to a burdensome approval process, and thereby alleviating the trend of long-term investors failing to adequately fund their retirement.

Financial investment processes: To create a new process and method for satisfying FINRA's suitability rule requirement.

### SUMMARY

In view of the aforementioned shortcoming, a regulatory compliance system according to the invention is provided and generally includes an investment module and a suitability module means. The investment module is provided for user input of user authentication and an investment request related to year of retirement, the investment module includes a means for submitting a user questionnaire form required for regulatory compliance of the investment request. The suitability module means provides verification of the questionnaire form data of the user and authorizes completion of the investment request in view of the year of retirement.

### BRIEF DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram of hardware infrastructure for a regulatory compliance system according to the invention;

FIG. 2 is a schematic diagram of a regulatory compliance system according to the invention;

FIG. 3 is a flow chart of exemplary steps performed by a regulatory compliance system according to the invention;

FIG. 4 is a schematic diagram of hardware infrastructure for front end and back end framework of a regulatory compliance system according to the invention;

FIG. 5 is a flow chart of exemplary steps performed by user authentication module for a regulatory compliance system according to the invention;

FIG. 6 is a schematic diagram of exemplary connection between a front end and a back end framework of a regulatory compliance system according to the invention; and

FIG. 7 is a schematic diagram of exemplary protocol between a front end and a back end framework of a regulatory compliance system according to the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

In an exemplary embodiment, the invention provides a regulatory compliance system having a suitability module to verify suitability rule requirements established under federal regulations or rules from a self-regulatory organization, such as Financial Industry Regulatory Authority (FINRA). For instance, the regulatory compliance system according to the invention may streamline investor entry into the investment market, as one aspect of assisting investors with an aim of helping users develop viable financial plans, collect useful data, and provide users with positive reinforcement and communication to help them implement, maintain, and successfully realize their plans for future financial stability.

In an exemplary embodiment, the regulatory compliance system provides a novel process and method for satisfying FINRA's suitability rule requirement. The invention provides to an algorithm performed by the suitability module that auto-populates the questions pertaining to suitability obligations established by FINRA requirements, for users, Registered Investment Advisors (on behalf of users) and Financial Advisors (on behalf of users). A user with an investment time horizon of greater than 20-years, investing in a pre-selected diversified fund, can and should out opt out of the current suitability requirements. FINRA can and should recognize that for these users the greater risk, is not investing.

More particularly, in an exemplary embodiment, the regulatory compliance system serves to streamline the required suitability processing as applied to younger investors—e.g., users having an age in the range of approximately 0-40 years, or alternatively, for those that indicate having at least 20 years remaining prior to retirement. For example, where the investor inputs an age of less than or equal 40, or alternatively, indicates “having greater than 20 years of work remaining” the result would be for the system to implement a process to project most likely responses to remaining questions in determining suitability as an investor, thereby the system may pre-populate the remaining substantive questions in the questionnaire to meet FINRA requirements and subject to the user's confirmation of the answers and approval, the system would auto-enroll the respondent as satisfying FINRA mandated suitability requirements. Thus, the regulatory compliance system would allow most potential investors under the age of 45, perhaps even those of up to 50 years old, to be preliminary identified in the system as suitable investors (complying with FINRA requirements), where the preliminary approval would be subject to the user's review and confirmation. It is likely, with the increase in life expectancy he regulatory/suitability age will increase. Through the user's opportunity to review and approve the preliminary approval, that user may assess their own suitability for a proposed investment vehicle, userly evaluating their subjective level of risk aversion, desired investment goal or any other factor that might cause them to countermand the preliminary suitability determination that had been based upon the indicated duration of their potential investment term.

Once an investor has reviewed and approved the responses to the suitability questionnaire, as populated by the regulatory compliance system, in response to the investor indicating a suitably long investment period, the regulatory compliance system would then archive or otherwise record the investor's answers and confirmation, along with the investor's status as meeting suitability requirements. The completed and investor approved suitability questionnaire would then be electronically stored in, for example, in a storage medium such as electronic memory in a database accessible via computer, such as memory of a server, computer, stored digitally in a cloud network, for example. It is contemplated that alternative questionnaire forms may be suitable, for example, confirmation email, including the completed questionnaire may be provided to the investor, or a paper copy of the completed questionnaire maybe printed and provided to the investor, with a copy stored by the broker/dealer, so as to be able to verify compliance with FINRA requirements at some point in the future.

The question of having at least 20 years of work remaining prior to retirement can often be determinative regarding a user's suitability as an investor, for the reason that, historically, there has not been any instance where, over any 20-year period, the S&P 500 has not realized at least 7% growth, annualized. Thus assuming that the period of investment is suitably long (e.g., at least 20 years), any other objective factor regarding suitability is not likely to countermand an initial determination of suitability of a user, with regard to investing in a vehicle tracking a diversified index fund, such as the S&P 500.

Similarly, in an exemplary embodiment, the regulatory compliance system would preliminarily determine suitability of an investor where the account is a custodial account (e.g., for minors under the age of 18), as the duration of investment growth would likely exceed 20 years. As above, the suitability determination would be preliminary until it is reviewed and confirmed by the responsible user, typically the custodian for the custodian account.

In another embodiment of the invention, the assessment as to suitability of an investor required by FINRA may be implemented as a “one click” operation to allow a first time purchase of the S&P 500, allowing the user to approve pre-populated answers to outdated, and often not relevant, suitability questions. Such a “one click” operation would be implemented where the investor has a pre-existing account with a financial institution, or where the investor is transferring funds into, or otherwise replenishing an account, through a formal account registration, set up and initial investment.

The typical investor that would be making an initial entry into a retirement fund would have at least 20 years before retirement, often has at least moderate risk tolerance, and is directing a modest amount into the retirement account, typically less than $1000. A “one click” operation may be suitable where the investor would already have previously entered basic information, such as is required for the creation of a financial account, including age, upon which the suitability for investment approval, in some circumstances, may readily be determined, subject to confirmation by the investor. It is also contemplated that the suitability of an investor may be determined, or supplemental information provided by accessing database containing information relevant to the potential investor, such as by accessing information provided to one or more of a banker custodian or clearance organization, or a broker/dealer, suitable databases may be maintained by suitable financial systems entities, for example, but not limited to, APEX, TD Ameritrade, Schwab, Drivewealth, etc. . . .

It is further contemplated that a “one click” operation may be enabled where the investor has participated in the game or application, as the user would have entered relevant user information (including for example, the user's age, income, retirement goal, career, geographic location and residence information) for the simulation to be performed. The user may have also granted access to their financial accounts. Some or all of the information entered or accessed relevant to the user may allow a conditional determination of suitability that would meet the FINRA requirement, subject to the user's confirmation. In such an instance, the software application using the regulatory compliance system may communicate or allow the suitability determination to be made by electronically accessing information entered into the application, which then may pre-populate answers for suitability, to be reviewed and approved by the user. In this manner, the act of completing the questionnaire for determining suitability as an investor can be generated, upon a single click instruction to do so by the user using a regulatory compliance system according to the invention. Furthermore, upon acceptance by the user, confirming suitability, the regulatory compliance system may trigger an automatic investment, by having linked a financial account (source of funds) to be invested into a retirement account. It is also contemplated that information may be obtained concerning the investor's suitability by datamining publicly accessible and privately accessible information, including information such as credit scores, user's age, geographic locale, dependents, occupation, and other factors that could impact a person's suitability.

In the practice of any embodiments of the invention, the intent is to help as many users as possible develop, implement, maintain, and successfully fulfill a plan for financial stability or independence. This may be accomplished by removing as many obstacles to investment as possible, for example, by reducing investor intimidation, such as may be achieved by providing an automated, fast, user-friendly suitability assessment.

In practice, the use of a regulatory compliance system according to the invention is marketed or otherwise made available to broker/dealers, or alternatively, the results of the assessment may be provided to brokers. For example, the regulatory compliance system necessary for the practice of the various embodiments described herein may be made available for license. Alternatively, the results of the assessment may be presented in an accessible database or digital medium (e.g., website or authorization portal), that may be updated periodically, or immediately as users assessments are determined. Access to the database may be granted, or licensed out to others, or the database may be physically or electronically distributed to FINRA authorized broker/dealers, to ensure efficiency for the investor. The method, or processes utilizing the various embodiments described herein may be potentially linked to, or incorporated into, major websites and financial advisory portals (i.e., including those of Troutwood or peers and competitors who have licensed the technology).

The traditionally applied process for suitability assessment is intended to allow the broker/dealer to identify and protect user investors that have risks affecting their suitability, even risks the investor might not be aware of; however, in the practice of the various embodiments described herein, where the user is of an age that will afford a suitably long investment period before withdrawing the funds, the overall balance of the risks weigh in favor of investing in a thoroughly vetted and well diversified index, such as the S&P 500. For at least this reason, it is contemplated that the approval process can be streamlined, as described by the various embodiments of the invention, for both the young investor, and also for those with at least 20 years prior to retirement.

In an exemplary embodiment, the user would have initially set up an account with the broker/dealer, registration, a process which, according to the teachings herein, may be streamlined, after having previously entered basic personal data, and optionally, the broker/dealer had performed a background check on the user. In the practice of the teachings herein, potential investors are able to make become approved as suitable investors, and optionally, make a one-click purchase of a diversified index fund. It is contemplated that the user would access a display screen with an input interface, so as to allow the potential investor to input information that could be utilized in completing the suitability questionnaire required by FINRA regulations.

Now with reference to the figures an exemplary embodiment is further described.

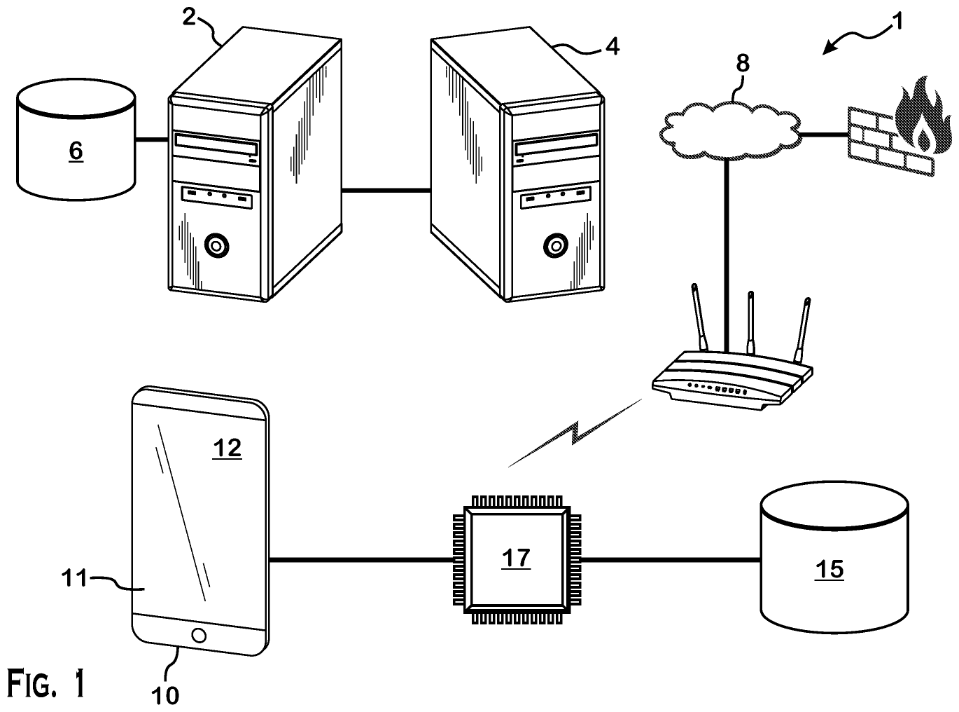

Referring first to FIG. 1, hardware infrastructure for an embodiment of the regulatory compliance system 1 will be described. To perform the aforementioned and other functions, the the regulatory compliance system 1 generally includes a plurality of integrated system servers 2, 4 with one or more company databases 6 (i.e. internal information repository), a network interface 8 accessible through various known communication protocols, such as TCP/IP, cellular protocols including GSM, Wi-Fi, Wi-Max, or other wireless communications technologies or combination of wired or wireless channels, network security devices (where necessary), and a computing device 10 having a processing unit and memory.

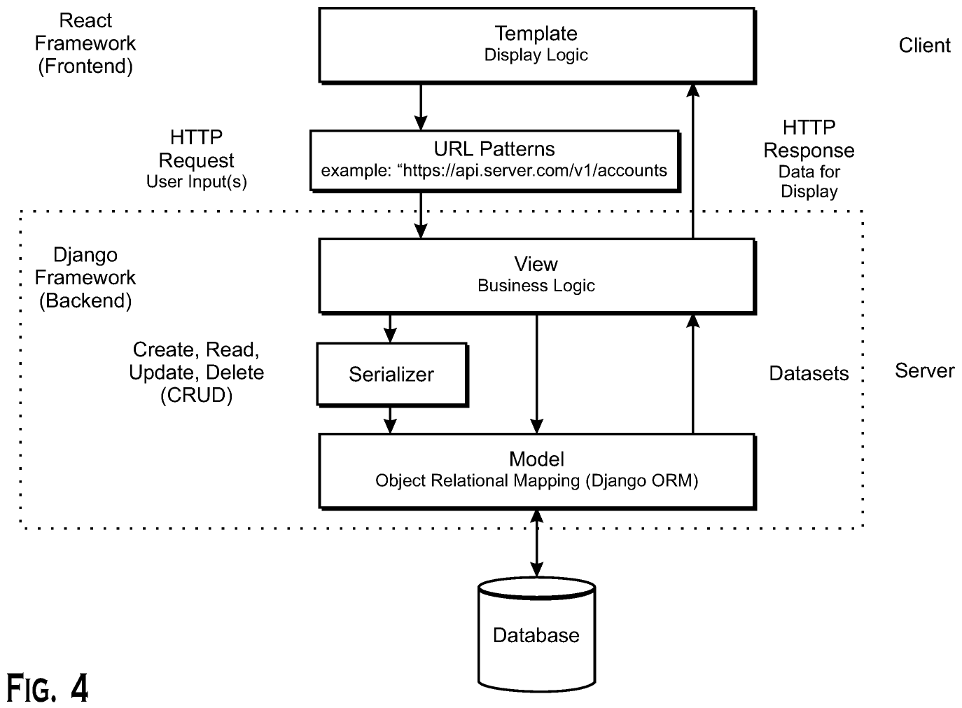

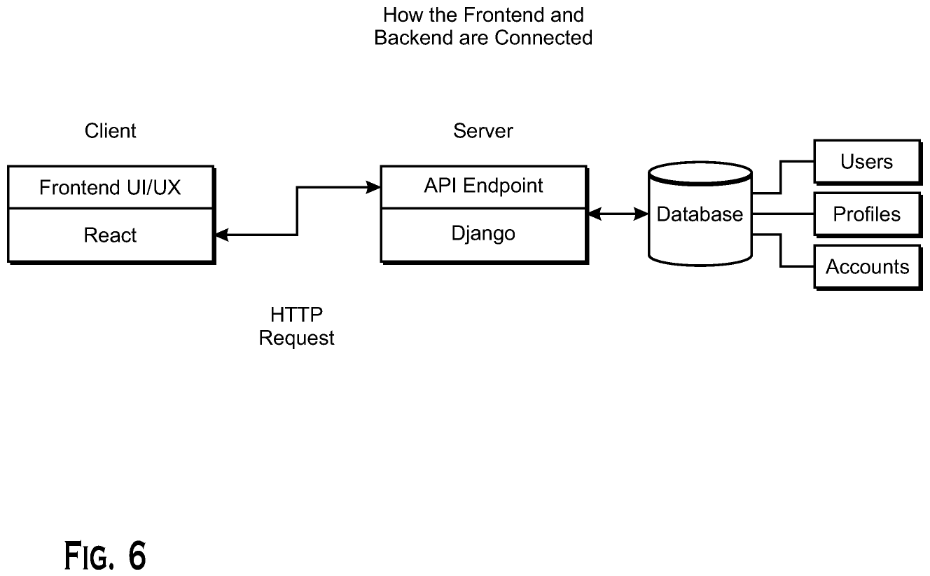

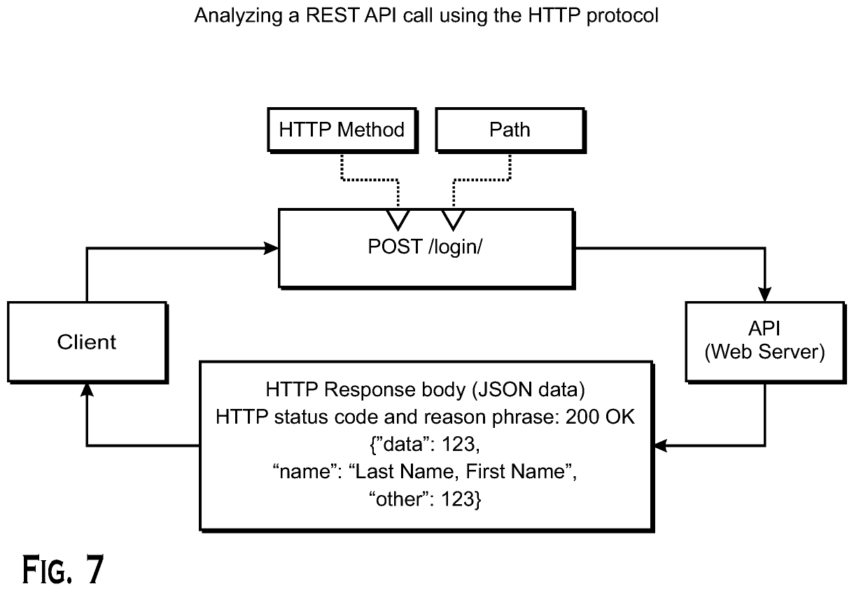

The regulatory compliance system 1 allows a user to access to a plurality of regulatory compliance system files that includes data, such as information and images, through the computing device 10 and a network traffic information on the database server 4 (i.e. SQLServer or PostgreSQL (also known as Postgres) or newer) that connects to a web server 6. The web server 4 functions as a way for network interface 8 to communicate to the database server 2 through known application-programming interface (API) between the computing device 10 and the database server 4. A firewall may be used for security purposes such as, but is not limited to, blocking unauthorized access to the web server 6 and permitting unauthorized communication thereto. The regulatory compliance system 1 is designed to run through the computing device 10 through the a a plurality of regulatory compliance system modules that are downloaded over personal area networks (PANs), local area networks (LANs), campus area networks (CANs), wide area networks (WANs), metropolitan area networks (MANs) and any new networking system developed in the future. One skilled in the art should appreciate that the regulatory compliance system 1 can be maintained solely through the computing device 10, as the regulatory compliance system modules can be pre-loaded to the computing device 10. In the shown embodiment, the user connects to the network interface 8 using the computing device 10 through the router for instance. FIG. 4 illustrates an exemplary embodiment of the front end and back end framework of the regulatory compliance system 1. FIGS. 6 and 7 also provide exemplary architecture and protocol for the regulatory compliance system 1. Though one skilled in the art would appreciate that other hardware and protocol designs are possible as long as such modifications would not divert from the spirit of the invention.

In a exemplary embodiment, the computing device 10 generally includes a general user interface 12, a processor 14, and a memory device 16. In the shown embodiment, the computing device 10 is a tablet computer or mobile phone device with a touchscreen display 11. The touchscreen display 11 uses finger or stylus gestures to navigate the general user interface 12. However, one skilled in the art should appreciate that other implements could be used; including a computer mouse, a keyboard, or joystick. In fact, one skilled in the art should appreciate that the computing device 10 is a physical computer and could be, but not limited to, a desktop computer, a laptop computer, or other processing device. The memory device 16 is a storage device having computer components and recording media used to retain digital data. The processor 14 is a central processing unit (CPU) that manipulates data stored in the memory device 16 by performing computations.

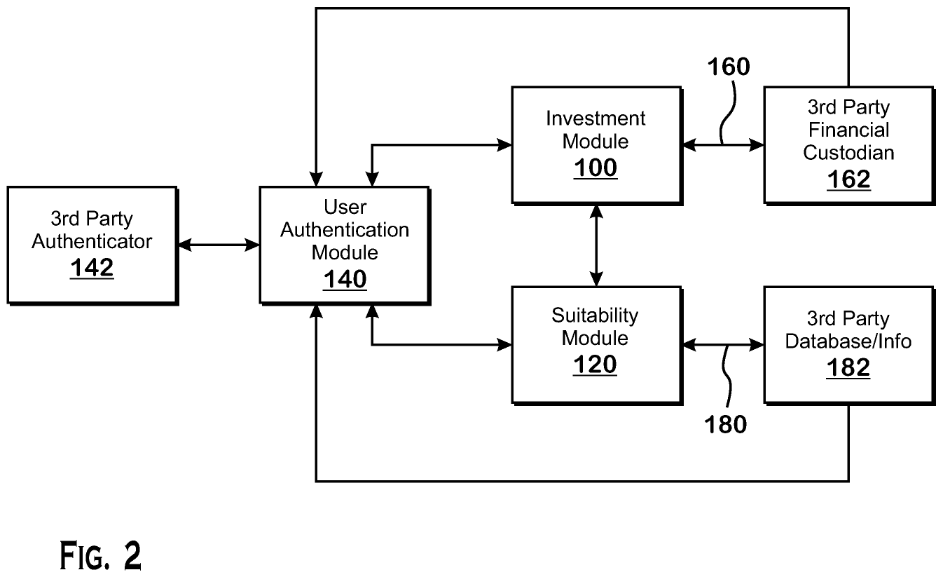

With reference to FIG. 2, the regulatory compliance system 1 will be described by way of illustration of the Now with reference to FIG. 2, the regulatory compliance system 1 will be described. The regulatory compliance system 1 includes an investment module 100, a suitability module 120, and a user authentication module 140, a third party financial custodian API 160, and a third party database vendor API 180.

In an exemplary embodiment of the invention, regulatory compliance system 1 uses these modules to perform the following fundamental steps for a user is interested in opening an investment account with the intention of becoming a long-term investor, and selects whether to utilize a brokerage firm or registered investment advisor through whom to invest:

(1) User next enters either their age, or “years to investment goal”

(2) If users time period is >20-years, the user is determined to have a long-term growth objective. A user who does not meet this standard would be defaulted into the existing suitability standards to best determine goals, investment objective and risk profile.

(3) Once user is determined to meet the 20+ year objective a choice is presented to invest in an “S&P 500 index Fund” or “Target Date Fund.” Note, that the selected Target Date Fund would match the years to goal selected in (1).

(4) If a brokerage firm was chosen, a drop down of available S&P 500 options is shown.

(5) If a registered investment advisors was chosen, the advisor selects the S&P 500 fund that best meets objectives.

(6) Account is approved and opening process begins.

In an exemplary embodiment, the investment module 100 is the hub of the regulatory compliance system 1. In an exemplary embodiment, a potential investor accesses investment module 100 running on the computing device 10 and enters information via the user interface displayed on a display screen. The investment module 100 would be a third party website, or standalone investment software that allows a user to invest wealth in the form of money or other assets into an entity, investment fund, or other investment opportunity. In certain embodiments, the investment module 100 provides a GUI on a the computing device 10 of a user, and provides downloaded data associated with the user to the user through the GUI (e.g., questionnaire forms to complete, allowing the user to view the data directly, providing one or more notifications and/or recommendations to the user based on the data, providing one or more tables or charts to the user based on the data, providing a summary of or one or more statistics related to the data, or the like).

For example, in one embodiments, where the data associated with a user comprises financial data, the investment module 100 may provide a data interface, an exchange interface, or the like wherein the user may view and/or otherwise access the user's financial portfolio and make changes thereof. In a further embodiment, where the data associated with a user comprises the user's financial transaction history (e.g., purchases and/or other financial transactions downloaded from one or more ecommerce or brokerage sites or other service providers; one or more financial institutions such as banks, credit unions, lenders, or the like; and/or another entity), the investment module 100 may provide a personal financial management interface, with a list of transactions (e.g., with item level data identifying multiple user items within a single purchase), one or more budgets, one or more financial goals, a management interface, and/or another personal financial management interface wherein the user may view the user's downloaded and/or aggregated financial transaction history, and/or alerts or recommendations based thereon. In another embodiment, where the data associated with a user comprises social media posts, the investment module 100 may provide a GUI comprising a stream, feed, and/or wall of social media posts for the user to view (e.g., downloaded and/or aggregated social media posts from multiple social networks, from different contacts or friends of the user, or the like).

In an exemplary embodiment, the user authentication module 140 is a set of instructions to authenticate the user of the investment module 100. In one embodiment, the authentication module 140 receives a user's electronic credentials for a third party service provider 142 from the user on computing device 10 of the user. In a further embodiment, the authentication module 140 may receive electronic credentials for a different user (e.g., from a different hardware device, from a backend aggregation module, or the like), which may be encrypted and/or otherwise secured, so that the direct access module may download data for the different user (e.g., downloading data for multiple users from a single user's computing device 10).

In one embodiment, as described above, electronic credentials may comprise one or more of a username and password, fingerprint scan, retinal scan, digital certificate, personal identification number (PIN), challenge response, security token, hardware token, software token, DNA sequence, signature, facial recognition, voice pattern recognition, bio-electric signals, two-factor authentication credentials, or other information whereby the authentication module 140 may authenticate and/or validate an identity of and/or an authorization of a user.

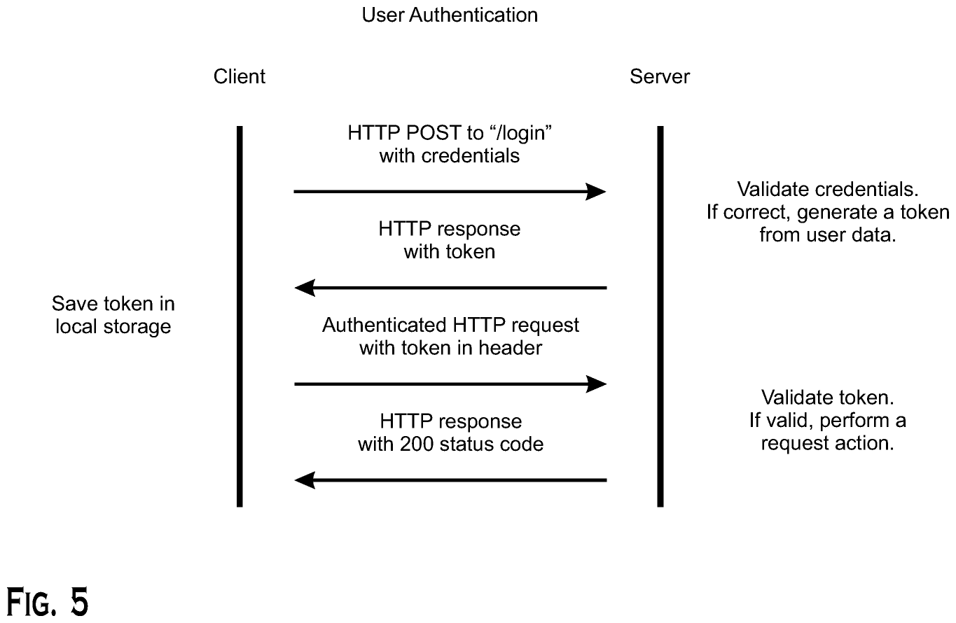

The authentication module 140, in certain embodiments, may receive different credentials from a user for different accounts of the user with different third party service providers (e.g., different ecommerce sites or other online retailers or service providers, different social networks, different photo sharing sites, different financial institutions) so that the investment module 100 or suitability module 120 may download, aggregate, and/or combine the user's data from the multiple different third party service providers 142, 162, 182. In one embodiment, the authentication module 140, instead of and/or in addition to receiving one or more passwords or other electronic credentials from a user, may manage and/or determine one or more passwords or other electronic credentials for a user for one or more third party service providers. For example, in certain embodiments, the authentication module 140 may receive an initial set of electronic credentials (e.g., a username and a password) from a user for an account of the user with a third party service provider, and the authentication module 140 may use the initial set of electronic credentials to access the user's account with the third party service provider to set a new password, determined by the authentication module 140. The authentication module 140, in one embodiment, may determine passwords or other electronic credentials that are more secure than those typically created by and/or memorable to a user (e.g., longer, more numbers, greater variation between capital and lowercase letters, more frequently changed, or the like). An example of protocol for the authentication module 140 is shown in FIG. 5.

The suitability module 120 is a set of instructions to streamline regulatory compliance of the user for any future transactions using the investment module 100. These could be transactions through an existing account set up through the investment module 100 or through a third party custodian (i.e. independent financial provider, brokerage firm). The suitability module 120 facilitates collection of data used to authorize that user to complete a financial transaction by populating and/or authenticating data needed for that compliance. One skilled in the art should appreciate the transaction can be initiated through other third parties including, but not limited, to a financial advisor and registered investment advisor.

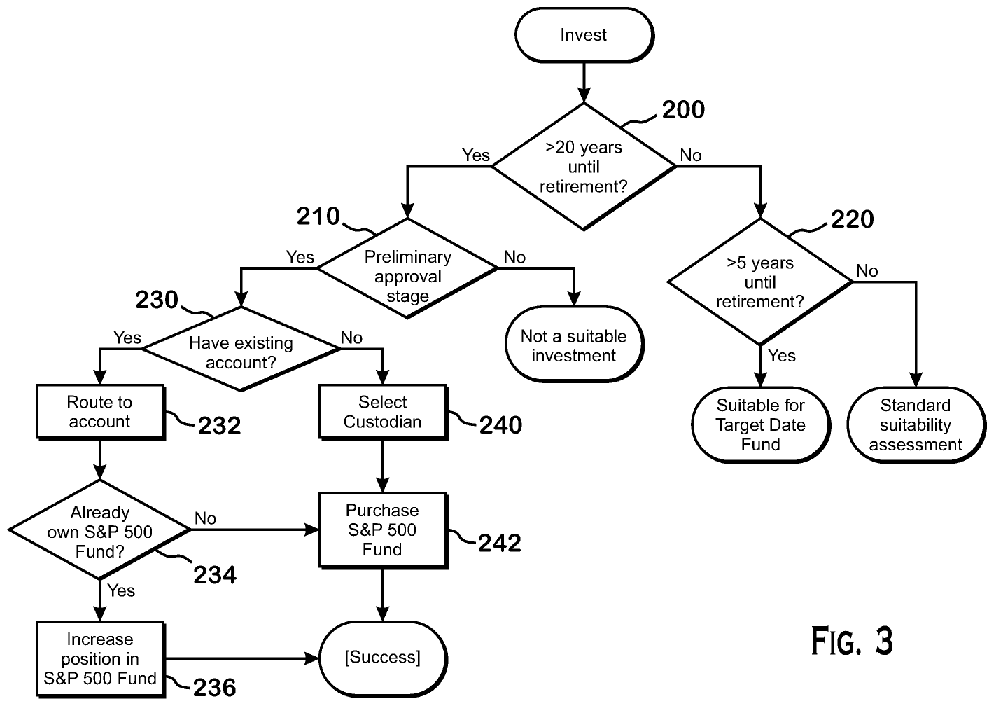

In practice, the regulatory compliance system 1, as illustrated in the flow chart depicted in FIG. 3, allows a user who is looking to fund a retirement account by investing through the investment module 110 that is a diversified index fund, such as the one that tracks the S&P 500, would utilize the investment module 140, and the display and interface to answer an initial question presented to the display device of the computing device 10.

The user opens the investment module 100 and provides authentication information, such as a username and password. This is then authenticated through the authentication module 140. One skilled the art should appreciate other information may be required to authenticate, including but not limited to user profile, address, privacy information, beneficiaries, etc. All documents may be used to authorize and verify the user. Again, one skilled in the art would appreciate that there are various authentication methods available.

Once the user's identification has been authenticated, the suitability module 140 verifies or populates data of the authenticated user, for instance, age and duration of time before the user will need to access the funds in an account. In an exemplary embodiment of the invention, as shown in FIG. 3, the suitability module 140 plugs into the investment module 100 to meet regulatory compliance of the user and actions to be performed by that user.

In exemplary embodiment, the user would utilize any suitable questionnaire form for inputting an answer through the interface of the investment module 100, such as by using a keyboard, mouse, stylus, or voice command, to provide an answer to the initial question via the software interface, to indicate that the investor has at least 20 years before needing to access the retirement account funds, or otherwise indicate being of 40 years of age or less. It is contemplated that the broker/dealer of the investment module 100 may opt to have the system set with a different threshold for either age, for example, not exceeding 41, 42, 43, 44, 45, or 50 years of age; alternatively, or the threshold for the duration of investment period in the retirement account may be a number of years other than 20, for example, in the range of 15 to 25 years. In the event that the investor is not able to respond in a manner that affirms the threshold question, the investment module 100 would indicate that the remaining questions would not be pre-populated, and ask the potential investor to provide the answers to satisfy the FINRA requirement for suitability. The standard suitability assessment may then be performed through using the suitability module 120 that permits streamlined assessment process may be universally employed by any broker/dealers subject to the FINRA requirements, with the aim of encouraging investment, reducing investors' intimidation, confusion and reluctance to engage in investing in their futures.

A streamlined suitability assessment, as contemplated herein would provide immediate benefit to both the investor, and the broker/dealer, but providing an objective, readily determined standard that can be quickly implemented, and lead to rapid confirmation as a suitable investor, meeting the FINRA requirements. In an exemplary embodiment of the invention, the suitability module 120 connects with a third party database vendor 180 through a third party database vendor API 182 to populate or verify information needed for the questionnaire form to verify suitability of the user. Such information may include user's name, address, social securing number, or other qualifying information needed for suitability or regulatory compliance. The authentication module 140 provides necessary authorization to access and download required user data from the third party database vendor 182.

More particularly, in an exemplary embodiment, the suitability module 140 processes suitability requirement for the user, such as younger investors—e.g., users having an age in the range of approximately 0-40 years, or alternatively, for those that indicate having at least 20 years remaining prior to retirement. For example, where the user inputs an age of less than or equal 40, or alternatively, indicates “having greater than 20 years of work remaining” the result would be for the system to implement a process to project most likely responses to remaining questions in determining suitability as an investor, thereby the system may pre-populate the remaining substantive questions in the questionnaire to meet FINRA requirements and subject to the user's confirmation of the answers and approval, the system would auto-enroll the respondent as satisfying FINRA mandated suitability requirements. Thus, the suitability module 120 qualifies user under the age of 45, perhaps even those of up to 50 years old, to be preliminary identified in the system as suitable investors (complying with FINRA requirements), where the preliminary approval would be subject to the user's review and confirmation. Through the user's opportunity to review and approve the preliminary approval, that user may assess their own suitability for a proposed investment vehicle, surely evaluating their subjective level of risk aversion, desired investment goal or any other factor that might cause them to countermand the preliminary suitability determination that had been based upon the indicated duration of their potential investment term. As such, the suitability module 120 streamlines a cumbersome and intimidating process that deters most young investors from completing the task of investing.

In the exemplary embodiment, for long term investment, the suitability module 120 automatically evaluates user suitability to meet FINRA compliance by addressing the (1) user's ability and (2) user's willingness. The ability to invest is presently determined by the user's financial status and future financial needs. Generally, a user with greater wealth and/or greater time to invest, is viewed as having a higher ability to invest. Within the context of this filing a user with 20+ years to invest in a long-term diversified investment fund, should be viewed as having the ability to invest in the long run. Pension funds have historically managed the “growth” percentage of their allocation similarly. Pension funds managed their allocation with % of beneficiaries who are working and average age of, (growth) versus % of beneficiaries who are retired and drawing down funds' assets (conservatively managed to ensure payments), and average age of that work force. The user's willingness to invest is determined the users risk tolerance, as determined by the current suitability process. Within the context of retirement, replacing the role of pension funds and social security, willingness, within the context of this patent filing and simplifying the process by which a user can open a long-term investment account, should be determined by the combination of replacing historically reliable sources of income, paired with time to do so. More time (in years) and recognition of the need to replace income for life provided by pension funds, equates to a greater willingness to invest. Less time (in years) equates to a lesser ability to invested

As step 200, where the response indicates that the user would have 20 or more years before accessing the funds, the suitbaility module 120 would automatically pre-populate the remaining suitability questions of the questionnaire form with proposed responses that have been observed to be appropriate in the majority of instances. For example, FINRA regulations (Rule 2111 Suitability) require the broker/dealer to assess “the customer's age, other investments, financial situation and needs, tax status, investment objectives, investment experience, investment time horizon, liquidity needs, risk tolerance, and any other information the customer may disclose to the member or associated person in connection with such recommendation.” In the absence of information to the contrary, the system would be instructed to prepopulate answers that indicate the user is new to investing, and lacks any significant investment experience, of low to moderate net worth, and would be suitable for investing an amount in a retirement fund for at least 20 years, where the investment vehicle is a diversified index, such as the S&P500. In such an instance, the system would auto populate responses in the questionnaire that are most likely applicable to a small investor, with little to no experience investing in the stock or bond market. Thus the responses would presume no other significant investments, no immediate liquidity requirements, and tax status suitable for investing in a retirement fund. Furthermore, the system would indicate moderate risk tolerance, as for the duration of the investment period, it is anticipated that the risk is low, given the historical precedent of strong returns over the course of 20 years.

The practice of the various embodiments described herein provides an improved process for suitability assessment with regard to FINRA regulations, and may be applicable for all investments made through either traditional brokerage firm/dealers or Registered Investment Advisors (RIAs). The embodiments of the invention described herein provide an improvement of the current state of the art, reducing complexity, and confusion in determining suitability of an investor, in that according to the methods taught herein, the users' age and/or the number of years left until retirement of the investor are preliminarily determinative of the investor's suitability for investing retirement funds in a diversified index fund. Note however, the approval is preliminary, and the user may opt to view other considerations as countermanding an initial determination of suitability. For example, the user may determine that there is a more pressing need for liquidity, and opt not to agree with investing in retirement accounts at the time, or the investor may have less risk tolerance than most other investors, rendering the proposed investment unsuitable for that user.

There is no currently available technology or tool that allows the suitability assessment to be streamlined, treating as determinative the duration of investment in a diversified index security, where the duration is determined by either a users' age, or “work years remaining to retirement.” By shifting the analysis to focus solely on such a factor, the suitability assessment can be streamlined significantly, reducing confusion and increasing efficiency in the broker/dealer serving the investor.

The various embodiments described herein would not be applicable where the planned security purchase would involve relatively higher risk than investment in a diversified index fund. For example, the purchase of user stocks, bonds and investment types with a greater risk profile, should remain subject to the known suitability assessment.

In an exemplary embodiment, applying the streamlined suitability process through the suitability module 120 would begin with the broker/dealer having to assess investors purchasing securities as part of retirement portfolio, where the securities to be purchased are a low risk vehicle, such as a diversified index fund. Representative diversified funds include those that track or are representative of the S&P500, an index of 500 of the largest U.S. companies, listed on the New York Stock Exchange or NASDAQ, selected by the Standard & Poor's Index Committee based on market capitalization.

Once a user is identified as meeting the criteria for a streamlined suitability assessment, the user would be asked to confirm that there are at least 20 years until the retirement account would need to be accessed at Step 200. An alternate confirmation approach could be to ensure the user is of a young age, for example, an age not exceeding 40, not exceeding 45, not exceeding 50. If the user is able to confirm having at least 20 years before requiring access to the retirement funds, or in the alternative is able to confirm being of an age that fits the instant age criteria, the user would indicate in the affirmative. This can be adjusted to meet regulatory compliance system 1 needs. For example, where the assessment is online or by electronic means, the user may click a mouse to select a response through the investment module 100 that indicates affirmation. If the user does not meet the criteria described, a standard suitability assessment should be performed by the suitability module 120, in compliance with FINRA regulations in order to proceed with an investment. In the circumstance that the user is able to demonstrate meeting the criteria for a streamlined assessment, the process as depicted in FIG. 3, would directly lead to a preliminary approval (Step 210), which if performed electronically, may be substantially instantaneous. The preliminary approval is then subject to assent by the user, who may object based on that user's subjective factors, such as being risk averse, requiring liquidity, or being desirous of in investment rationale other than long-term growth. Upon confirmation by the user of the preliminary approval status prepared by the algorithm of the suitability module 120, that user would then be characterized as a suitable investor for the purposes of the broker/dealer having the necessary authorization under FINRA regulations to proceed with the purchase of the securities sought for the users' retirement portfolio.

In circumstances where the user is unable to confirm that the retirement funds would not be accessed for at least 20 years (Step 220), the user may assent to investing a reduced percentage of retirement funds into a diversified index security, such as the S&P 500, and instead divert the balance of the funds into a vehicle having less risk. For example, where the user indicates being of an age of 50, the algorithm may adjust the approval assessment and preliminary approve the user for suitability consistent with directing, for example, 80% of the capital into a vehicle such as the S&P 500; and 20% of the capital into a fixed income vehicle. In this manner, an appropriate level of risk can be tailored for that user, given the shorter duration of the investment period before requiring access to the retirement funds. As the age of the user increases yearly above 40, the algorithm for the suitability module 120 would recommend reducing the proportion of the capital directed into the S&P500, and directing the balance into a vehicle that is less subject to volatility, that provides acceptable return, such as a fixed income vehicle. The user will have the ability to evaluate the recommendation, weigh the risks, and exercise independent judgement in whether to accept or reject the recommendation presented as part of the preliminary approval. It is to be expected that in such circumstances, the assessment would not fit into the category of a “one click” operation, but may require confirmation of amounts, and indicate assent to the recommendation; however, much of the questionnaire form that is to be presented for approval by the user may be prepopulated with information provided by the algorithm. It is contemplated that a user under certain circumstances (e.g. a user with greater risk tolerance, or longer personal time horizon) may elect to adjust the recommendation and invest the entire amount in the selected vehicle, such as the S&P500 index. The suitability module 120 may also use already stored social media data, or bank data to accomplish this same type of vetting process. Additionally, the investor, in reviewing any of the prepopulated answers in the suitability questionnaire form may elect to revise an answer in that investor's discretion; alternatively, the investor that may have been identified as not suitable for the streamlined assessment, may opt to elect the answers that are prepopulated for investors that are approved, so long as the investor is willing to accept the liability and consequences of opting to override the processed option.

The use of the various embodiments of the invention described herein enables a broker/dealer to satisfy the FINRA requirements for determining the suitability of a potential investor. The suitability assessment process through the suitability module 120 can be streamlined by auto populating the questionnaire form responses based on an initial question establishing that the retirement fund investor is looking for a suitably long investment period within a diversified index fund that provides long-term growth, and yet minimizes risk by averaging annualized returns over an extended period. The prepopulated questionnaire form approving the investor's suitability must also be confirmed and approved by the investor. The response and approval may then be recorded or digitally stored in a database accessed by the software. This database may be accessed in the future by the broker/dealer to provide evidence that the investment recommended to the user was appropriate, given the circumstances in place at the time. For users that satisfy a two-part equation of (1) years to goal and (2) investment type. a user enters an age falling in the range of 0-40 years paired with an expected retirement age of 60 years of age or older; or auto-populates the Troutwood Suitability questions for users that enter a number of work years, or “years to achieve investment objective” remaining for the user is greater than “20”. If years to goal satisfies this 20+ years “to go” requirement, the user may then select one of two investment types, an S&P 500 index fund and/or Target Date Fund of the users, RIA or FAs choosing. This process in intended to simplify the onboard process for non-investors, first time investors and young investors for whom the current suitability standards are ineffective and serve more as a deterrent to invest, than as a measure of a younger user's risk tolerance and diversification needs. The greater risk for a user with 20+“years to goal” is choosing not to invest or being deterred from doing so. Changing retirement plan type and availability, make this financial investment process essential. Users, in most cases, must replicate the Long-term approach utilized historically by the traditional pension system in America, the defined benefit plan. Defined Benefit Plans manage(d) assets on behalf of plan beneficiaries with a two-part approach. A growth-oriented asset allocation for current employees to ensure growth of assets, to meet these future obligations. A conservatively oriented asset allocation for retired workers, and from which to ensure the payment of earned benefits (i.e. retirement payments). The growth-oriented piece of this formula is the one that applies to qualified users current and future members of the work force, who must replace employer directed retirement planning, which provided guaranteed income for life, with employee directed alternatives. This growth-oriented asset allocation was and is managed for long-term appreciation and not for income disbursement.

At this point, the suitability module 120 identifies that the user is a suitable investor and meets preliminary approval Step 210. If the user endorses preliminary approval, then the investment module 100 will determine if the user has an existing account through the company managing the investment module (Step 230). If the user has an existing account, the investment module 100 will route to that account and allow the user to make in an initial investment request (Step 234) or subsequent investment request if the user is a current securities holder (Step 236).

If the user endorses preliminary approval, then the investment module 100 will allow the user to access a custodian account or 3^{rd} party institution to make in an initial investment request (Step 240) or subsequent investment request if the user is a current securities holder (Step 242). This is performed through the authentication module 140 verifying the user account and the suitability module 120 providing verification that the user is a suitable investor under regulatory compliance.

If the user is identifies as a non-suitable investor (Step 220), the suitability module 120 instructs the investment module 100 to present a target date fund based on existing suitability standards for investment goals, objectives and risk profile for the non-suitable investor with more than 5 years left until year of retirement. If the non-suitable user has less than 5 years left until year of retirement then the user regulatory suitability is performed through a standard suitability assessment.

In practice, the regulatory compliance system 1 described herein provide the benefit of simplifying an investor's entry into saving for retirement in an investment account. In suitable circumstances, where the suitability requirement questionnaire is pre-populated with answers that need be confirmed or otherwise approved, the system would streamline the process by accessing multiple sources of relevant information known about the user's financial background, goals, and pre-populates suitability requirement questions; thereby reducing the burden to the investor and reducing the time burden faced by the investor in determining suitability for the desired investments. Even if the duration of time required for pre-approval is reduced by a minor amount, the questions for determining suitability are automatically answered, thereby reducing potential obstacles to determining the investor's suitability. It is contemplated that the suitability assessment algorithm would run during the period of time that ACH verification is taking place.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A regulatory compliance system, comprising
an investment module for user input of user authentication and an investment request related to year of retirement, the investment module having a user questionnaire form required for regulatory compliance of the investment request; and
a suitability module means for verifying questionnaire form data for the user and authorizing completion of the investment request in view of the year of retirement.

2. The regulatory compliance system of claim 1, wherein the suitability module means provides preliminary approval of user's ability to invest as determined by user's financial status and calculated financial needs.

3. The regulatory compliance system of claim 2, wherein the suitability module means provides preliminary approval of user's willingness to invest based on the user's risk tolerance as determined by the user questionnaire form.

4. The regulatory compliance system of claim 1, wherein the suitability module means retrieves user questionnaire form data through a third party database vendor using a third party database API to verify form questionnaire data entered by the user.

5. The regulatory compliance system of claim 1, wherein the suitability module means retrieves user questionnaire form data through a collection of user data held on to verify form questionnaire data entered by the user.

6. The regulatory compliance system of claim 4, wherein the suitability module means retrieves user questionnaire form data through the third party database vendor to prepopulate user questionnaire form data or change form questionnaire data entered by the user.

7. The regulatory compliance system of claim 5, wherein the user verifies prepopulated or changed data for the form questionnaire to be processed for preliminary approval.

8. The regulatory compliance system of claim 1, wherein the suitability module means verifies if the user has 20 plus years until expected age of retirement and determines that user has a willingness to meet a long-term growth objective for retirement.

9. The regulatory compliance system of claim 7, wherein the suitability module means identifies if the user has less than 20 years until expected age of retirement and instructs the investment module to defaults the user into existing suitability standards for investment goals, objectives and risk profile.

10. The regulatory compliance system of claim 8, wherein the investment modules presents an opportunity for user to purchase target date fund for a non-suitable investor matching years left to the year of retirement.

11. The regulatory compliance system of claim 9, wherein the suitability module means provides preliminary approval of user's ability to invest by qualifying user's willingness to invest based on age in view of the year of retirement.

12. The regulatory compliance system of claim 10, wherein the suitability module means instructs the investment module to present preliminary approval verification to user and request to review and confirmation a completed form questionnaire for regulatory compliance.

13. The regulatory compliance system of claim 11, wherein the investment module makes an initial investment purchase for the user of an existing account that has been designated as a suitable investor.

14. The regulatory compliance system of claim 12, wherein the investment module is authorized to makes additional investment purchase for the user of the existing account of the suitable investor.

15. The regulatory compliance system of claim 11, wherein the user selects a custodian to makes an initial investment purchase once the user is determines to be a suitable investor.

16. The regulatory compliance system of claim 14, wherein the investment module provides authorization to the custodian that user has met suitability for regulatory compliance of the investment request or any future investment request.

17. The regulatory compliance system of claim 1, further comprising an authentication module to authenticate the user of the investment module.

18. The regulatory compliance system of claim 17, wherein the authentication module receives user electronic credentials from a third party service provider from the user on computing device of the user.

19. The regulatory compliance system of claim 19, wherein the authentication module receives different credentials from the user for different accounts of the user with different third party service providers so that the investment module or suitability module means may download, aggregate, or combine the user's data from the multiple different third party service providers.
